(19) United States
(12) Patent Application Publication
(10) Pub. No.: US 2002/0196924 A1
(43) Pub. Date: Dec. 26, 2002

(54) MIC - MAP & IN converter

(76) Inventor: Harel Dahari, Ganei Tikva (IL)

Correspondence Address: KATTEN MUCHIN ZAVIS ROSENMAN, 575 MADISON AVENUE, NEW YORK, NY, 10022-2585, US

(21) Appl. No.: 10/177,973

(22) Filed: Jun. 20, 2002

(30) Foreign Application Priority Data
Jun. 20, 2001 (IL) 143879

(51) Int. Cl. H04M 7/00; H04Q 7/20

(52) U.S. Cl. 379/220.01; 455/466

(57) ABSTRACT

The present invention provides a mediating communication system enabling to integrate mobile service providers such as SMS messaging with prepaid voice systems. It is suggested to use a mediating gateway, which simulates the communication between a signaling transfer point (STP) with a service control point (SCP) by converting MAP protocol messages of service switching point (SSP) into IN protocol messages which can be handled by the SCP.

### FIELD AND BACKGROUND OF THE INVENTION

### Definition: MAP represents all of the SMSC protocols (such as MAP, IS41, proprietary, etc. . . .) and not only the MAP protocol itself.

The present invention relates to telephony systems and, more particularly, to a telephony system that enables telephony service provider to combine Intelligent Network (IN) services with mobile services.

SSP—The Service Switching point (SSP) provides switching capabilities between different network elements such as mobile stations, PSTN and other peripherals. It has the ability to detect events during call processing, called triggers, that indicate an IN call event. After triggering, the SSP suspends call processing and starts a series of transactions with the SCP to determine the handling of the call.

SCP—The Service Control Point (SCP) is a real-time database and transaction processing system that provides service control. It performs subscriber or application specific service logic in response to a query from SSP and then sends back instructions how to continue call processing.

STP—The Signaling Transfer Point (STP) is a packet switch in the signaling network that handles distribution of control signals between different elements of the network.

In an IN based prepaid system all system logic is contained in the SCP. When a prepaid subscriber initiates a call, the STP detects the event and sends a query request to the SCP. Based on the source and destination and additional billing rules located in the database, the SCP returns the STP corresponding charging parameters and the maximum call duration allowed. If the subscriber's balance is lower then the amount required for making the call, the call request will be denied. Otherwise the STP will connect the subscriber to the destination requested and on call termination it would send a charge request to the SCP.

Today mobile services are growing rapidly but the functionalities are very primitive and not connected to the intelligent network, for example using the SMSC (short message service center) there is no easy way to provide pre-paid services that include an SMS billing application, the options are either integration to the pre-paid system, that can be very hard or impossible, (depending on the interface of the pre-paid system) or to make a simulation of a call to the SMS when an SMS arrive, such solution, creates load on the SSP (switch service point) and take time and a lot of hardware. What is needed is an option to create a connection between the IN environment and the SMSC environment, and to be able to create logic rules between them. On the same principle when we create IN services there is no option regarding the mobile service, for example a prepaid system that sends an SMS to a special destination every time a call was made with the duration of the call, again achieving this feature could easily have been achieved if we had some connection between the *IN environment and the **MAP environment.

The converter is the invention, MIC (Map & IN Converter) can receive either MAP protocol or IN protocol message and according to a predefined logic rules, which determine what to send forward/backward. The MIC is also capable to work as a special SMSC.

So what's the problem?

IN platform are complex systems and require in-depth understanding of its architecture and protocols. Although IN standards such as CS-1 and CS-2 were defined and accepted by the industry each switch vendor enhances its protocol so more capabilities can be added. Newer standards such as CAMEL and PARLAY are not yet widely adopted by the industry and it will take the vendors a few years until they implement and market them. This makes things more difficult and more complicated for IN solution developers.

Prepaid systems made by switch vendors as well as other vendors are usually voice oriented. They offer a wide range of options in order to charge voice calls but they almost do not offer any simple way to charge Data and Value Added Services. As a result most of these services such as messaging, entertainment and information are not charged for prepaid subscribers or charged in a poor and inadequate manner.

Prepaid systems are closed systems. They do not provide any open API for third party developers in order to integrate with these systems and exploit the capabilities of prepaid infrastructure. Thus many Data and VAS providers are not able to integrate to prepaid systems and unable to offer these services to prepaid subscribers.

Telecom operators invest millions of dollars and a great deal of time in buying, assimilating and operating prepaid systems. Replacing or upgrading these systems is done every few years due to the high costs involved. Thus telecom operators are looking for a low cost solution that can offer an easy way to interconnect Data and Value Added Services with the prepaid systems thus enabling them to maximize revenues from existing and new services.

### SUMMARY OF THE INVENTION

The present invention provides as follows:

a) The ability to convert stream or a single IN messages into stream or single MAP messages

b) The ability to convert stream or a single MAP messages into stream or single IN messages

c) Enabling telephone service provider to connect between the MAP environment and the IN environment.

d) The ability to act as an SMSC and be able to support IN Messages.

The present invention will allow leaving the control of the call services like billing etc' to the existing SCP (service control point) by connecting it to the SMSC allowing communication between the two elements.

Also, as specified in the preferred embodiments of the invention, the invention provides for the utilization of the invention in a voice over IP environment.

*IN environment—any equipment connected throw IN protocol.

**MAP environment—any equipment connected throw MAP protocol.

### BRIEF DESCRIPTION OF THE DRAWINGS

The invention is herein described, by way of example only, with reference to the accompanying drawings, wherein:

FIG. 1: Scenario description of SMS prepaid system.

ID:

ID 1: Normal Mobile telephone switch with IN capability.

ID 2: Normal mobile subscriber.

ID 3: Normal Service Transfer Point—keep signaling redundancy.

ID 4: Normal Short Message Service Center.

ID 5: Any prepaid system.

ID 6: Normal Service Control Point.

ID 7: The invention—M.I.C.

Flow Chart:

1. 2 sends an SMS message that arrive to 7

2. 7 sends an IN message—Call arrive to 6

3. 6 decide that this is a prepaid and send request to 5

4. 5 approve that call and send approve to 6

5. 6 return the result to 7

6. 7 send the SMS to 4

### DESCRIPTION OF THE PREFERRED EMBODIMENTS

The main concept of the present invention is to use existing Service Control Points (SCP) systems of cellular service providers, which are capable of handling prepaid voice calls for handling other providers services such as SMS messaging. It is suggested to use a gateway service for simulating data service request as if it was a voice calls request.

The present invention suggests a new mediating communication method for integrating mobile providers services with prepaid application, the integrated system comprise: a mobile service telephone switching point (SSP) which handles Intelligent Network (IN) protocol based messages, a service control point (SCP) and signaling transfer point (STP).

The mediating communication method is implemented within a designated gateway server. This gateway server, receives a stream of messages from a user's mobile telephone based on the MAP protocol. The messages operation state and ID are identified according to pre-defined logic rules. Based on operation state and ID requested service operation is identified according to pre-defined data tables. Based on the identified service operation, equivalent IN protocol messages are created having respective parameter type and values, which are determined according to equivalent parameters of the MAP protocol massages. The Created stream of IN protocol messages are sent to SCP system. The SCP system process receives IN message and returns results, which are based on the service providers database. The results are transmitted by IN messages back to the gateway server. Based on said result the gateway server activates the respective service according to determined requested service.

The mediating communication method can receive messages from SCP systems and convert them into IN protocol messages. The converting process is equivalent to above described process. Each received message operation state and ID is identified and the required service operation is determined accordingly based on pre-defined rules. Based on the determined service operations, the respective MAP messages are created. These MAP messages type and parameters are determined according to the received IN messages status and ID. and are sent to STP system for activating the respective service operation, based on determined required service and response message data result.

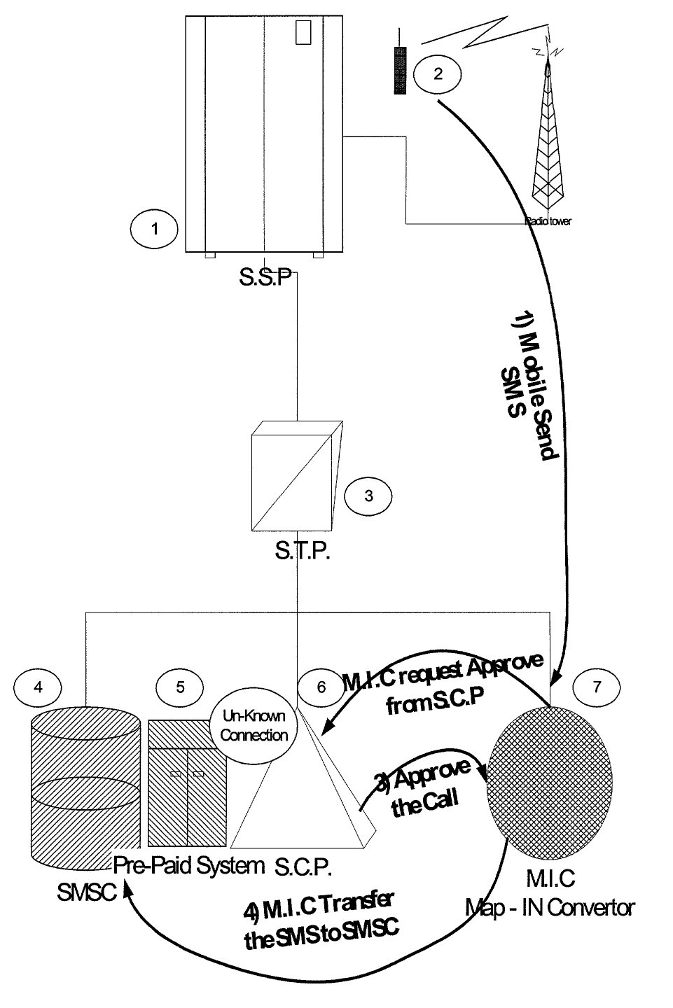

Referring now to the drawings, FIG. 1 illustrates a scenario description when a prepaid subscriber wants to send SMS message.

If the subscriber is within the limit of his prepaid account, then the prepaid system should approve the SMS, the MIC receives the message which detects that this is a prepaid customer and simulate a call arrive to the SCP in the same way that the SSP send the message of a normal prepaid call since the SCP look at the request as any normal request and detects that the call is from a prepaid subscriber.

The SCP sends a request the prepaid system, the prepaid system can either approve the call or reject the call (call˜sms message).

The SCP receives the approved message and sends Connect call message to the MIC for performing a SSP request. The MIC receives the approve message and allow the SMS to continue to the SMSC.

The MIC then can send a billing message that depends on SCP charges of an SMS message. The message transmission takes place after the MIC sends the message to the SMSC or after receiving approve from the SMSC or after quantum of time.

The telephone service providers are provided with solution for mobile services integrated with intelligent network services and the ability to implement such solution with no changes in the current configuration or hardware of the service provider network. For implementing such method it is first required to determine what system operations the MIC should simulate. Then selecting the network communication equipments the MIC should be able to communicate with. The MIC should comprise a configuration database, which include states and ID's of the incoming messages. The database further comprises scenario processes which are related to messages ID and state. The configuration data can be changed in realtime, not requiring to restart the systems. The providers' mobile service system can be reverted to its original operation, without the intervention of the MIC. The system can be Configured to work with the SS7 network.

### Example No. 2—FreePhone/Personal/Premium Numbers

1. Subscriber “A” sends an SMS message to a FreePhone number (1-800-xxxxxx).

2. The SSP redirect the message to the MIC instead of the existing SMSC.

3. The MIC send an IN query/ies to the existing SCP (the MIC simulate the SSP).

4. The SCP response to the MIC, in the same way it responds to the SSP.

5. Upon response reception the MIC can do one of the following actions:

a. Behave as an SMSC and send the message to the destination according to the received information.

b. Build a MAP message (according to the SCP response) and send it to the existing SMSC to handle this transaction.

6. MIC can generate a CDR (Call Detailed record) for this transaction.

The same steps are valid for Personal and Premium numbers. R\1\0\4

What is claimed is:

1. A mediating communication method for integrating mobile services system with pre-paid applications, said integration comprised of: a mobile service telephone switching point (SSP), service control point (SCP) and signaling transfer point (STP), said method comprising the steps of:
a. Receiving a stream of messages from the users mobile telephone based on a MAP protocol;
b. identifying MAP protocol messages operation States and IDs according to pre-defined logic rules;
c. determining requested service operation according to pre-defined tables based on identified state and id;
d. determining IN protocol messages type based on determined service operation;
e. determining IN protocol message parameter type and value according original message state.
f. Creating stream of IN protocol messages according to determined service requests;
g. Sending created messages to SCP system;
h. Receiving IN protocol response message from the SCP system;
i. Activating the respective service based on determined requested service and response message data result.

2. A mediating communication method of claim 1 further comprising the step of:
a. Receiving IN protocol message from the SCP system;
b. identifying messages operation State and ID according to pre-defined logic rules;
c. determining required service operation according to pre-defined tables based of identified state and ID;
d. determining MAP protocol messages type based on determined service operation;
e. determining MAP protocol messages parameters types and value according original message state.
f. Creating stream of MAP protocol messages according to determined service requests and parameters;
g. Sending created messages to STP system.
h. Activating the respective service operation based on determined required service and response message data result.

3. A communication method of claim 1 further enabling to apply IN capabilities to SMSC, said method further comprising the steps of:
a. Save the SMS message.
b. Identify messages transmission failures.
c. Retransmit messages, which failed to reach their transmission.

4. The communication method of claim 1 further enabling to send SMS messages to special numbers such as FreePhone (1-800) or premium (1-700) using the exciting logical and physical mechanism of the existing IN infrastructure, said method further comprising the steps of:
a. Sending subscriver SMS message to a special number (such as 1-800-xxxxxxx)
b. Upon message reception by the SMSC simulating the SSP operation, creating an equivalent INAP message and sending it to the SCP.
c. The SCP returns a response with the same logic to the SMSC as if it received a query message from normal SSP).
d. The SMSC receives the INAP response from the SCP and handles the SMS message according to respective response information. E.g. sending messages to destination, rejecting message.
